(19) United States
(12) Patent Application Publication
(10) Pub. No.: US 2020/0264298 A1
(43) Pub. Date: Aug. 20, 2020

(54) MULTI-SIGNAL WEAPON DETECTOR

(71) Applicants: Eric Haseltine, Rancho Palos Verdes, CA (US); Charles GANDY, Rancho Palos Verdes, CA (US)

(72) Inventors: Eric HASELTINE, Rancho Palos Verdes, CA (US); Charles GANDY, Annapolis, MD (US)

(21) Appl. No.: 16/538,111

(22) Filed: Aug. 12, 2019

Related U.S. Application Data
(60) Provisional application No. 62/807,705, filed on Feb. 19, 2019.

(51) Int. Cl. G01S 13/86; G01S 13/88; G01V 3/08; G01V 9/00; G01V 11/00

(52) U.S. Cl. CPC G01S 13/86; G01S 13/887; G01V 11/00; G01V 9/00; G01V 3/08

(57) ABSTRACT

In some embodiments, an apparatus includes a weapon detection system having a radar subsystem and a magnetometer. The radar subsystem is configured to detect a set of radio frequency (RF) response signals from an item under test (IUT). The magnetometer is configured to detect a set of magnetic response signals from the IUT. The weapon detection system is configured to calculate a composite multi-source detection signal based on the set of RF response signals and the set of magnetic response signals.

### CROSS-REFERENCE TO RELATED APPLICATION

This application is a non-provisional of and claims priority under 35 U.S.C. § 119 to U.S. provisional application Ser. No. 62/807,705, filed on Feb. 19, 2019, and entitled “Multi-Signal Weapon Detector,” the disclosure of which is incorporated herein by reference in its entirety.

### BACKGROUND

Known weapon detectors such as X-ray detectors, pulse induction metal detectors and backscatter radars are time consuming to operate and therefore create bottlenecks that can cause significant accumulation of individuals awaiting scan, which in turn can create significant numbers of vulnerable “soft targets” outside of protected areas. The 2017 Manchester bomb attack was an example where an attacker exploited the soft-target problem of the bottlenecked checkpoints.

Much of the bottlenecks problem at weapons scanner checkpoints arises because individuals to be scanned must empty their pockets, remove shoes and belts, and submit their hand baggage to time consuming secondary checks. False alarms triggering additional scans from hand-held metals detectors or chemical sensors further add to the time used to scan and clear each individual.

Thus a need exists to significantly speed up weapons checks so that soft target accumulation is greatly reduced. For example by allowing individuals to be scanned to keep metal objects in their pockets, hand baggage, and to wear their belts and shoes. A need also exists to improve on both the sensitivity and specificity of existing weapon detection systems.

### SUMMARY

In some embodiments, an apparatus includes a weapon detection system having a radar subsystem and a magnetometer. The radar subsystem is configured to detect a set of radio frequency (RF) response signals from an item under test (IUT). The magnetometer is configured to detect a set of magnetic response signals from the IUT. The weapon detection system is configured to calculate a composite multi-source detection signal based on the set of RF response signals and the set of magnetic response signals.

### BRIEF DESCRIPTION OF THE DRAWINGS

FIG. 1A is a schematic diagram of a weapon detection system, according to an embodiment.

FIG. 1B is a schematic diagram of a weapon detection system, according to an embodiment.

FIGS. 2A-2C show examples of a spectrum analyzer output under three conditions, accordingly to an embodiment.

FIG. 3 shows an algorithm to combine multiple signals in relation to the move/scan cycle of the weapon detection system, according to some embodiments.

FIG. 4 shows graphs of the spectrum amplitude relative to the frequency of the source, according to an embodiment.

FIG. 5A shows an example of a hysteresis curve in a magnetic flux—magnetization (“B-H”) plot, accordingly to an embodiment.

FIG. 5B shows a graph of magnetometer signal amplitude versus time for a pulse induction method of detecting “hard” ferro-metals of weapons, according to an embodiment.

FIG. 6 shows an output of a magnetometer of a set of magnetic signals, according to an embodiment.

FIG. 7 shows spatial gain profiles of objects detected by the weapon detection system, according to an embodiment.

FIG. 8 shows a measurement of a set of radio frequency (RF) response signals of an item under test (IUT) taken by the weapon detection system, according to an embodiment.

FIG. 9 shows spatial gain profiles of objects detected by the weapon detection system, according to an embodiment.

FIG. 10 shows a measurement of a set of radio frequency (RF) response signals of an item under test (IUT) taken by the weapon detection system, according to an embodiment.

FIG. 11 shows a measurement of a set of radio frequency (RF) response signals of an item under test (IUT) taken by the weapon detection system, according to an embodiment.

FIG. 12 shows a schematic diagram of the weapon detection system, according to an embodiment.

FIG. 13 shows a schematic diagram of the weapon detection system configured to detect weapon on a person, according to an embodiment.

FIG. 14 shows spatial gain profiles of objects and persons detected by the weapon detection system, according to an embodiment.

FIG. 15A shows a schematic diagram of the weapon detection system, according to an embodiment.

FIG. 15B shows a measurement of a set of radio frequency (RF) response signals of an item under test (IUT) carried by a person taken by the weapon detection system, according to an embodiment.

FIG. 16 shows a measurement of a set of radio frequency (RF) response signals of an item under test (IUT) carried by a person taken by the weapon detection system, according to an embodiment.

FIGS. 17A and 17B show measurements of a set of radio frequency (RF) response signals of an item under test (IUT) carried by a person taken by the weapon detection system, according to an embodiment.

FIG. 18 shows a schematic diagram of the weapon detection system, according to an embodiment.

FIG. 19 shows a measurement of a set of radio frequency (RF) response signals of an item under test (IUT) taken by the weapon detection system, according to an embodiment.

FIG. 20 shows a measurement of a set of magnetic response signals of an item under test (IUT) taken by the weapon detection system, according to an embodiment.

FIG. 21 shows a schematic diagram of the weapon detection system, according to an embodiment.

FIG. 22 shows a schematic diagram of the weapon detection system, according to an embodiment.

### DETAILED DESCRIPTION

In some embodiments, multiple, quasi-independent signal evocation is used such that targets, such as firearms, knives and improvised explosive devices with fragmentation materials such as nails or ball bearings are detected and differentiated from clutter, i.e., signals from non-weapon metallic objects such as mobile devices, keys, belts, nail clippers, and steel shanks of shoes.

The majority of weapons of concern, contain high carbon steel or stainless steel having linear dimensions greater than two inches, and with metallurgy that offers opportunities for uniquely identifying the presence of such objects. Some embodiments described herein can exploit at least one of several unique properties of most weapons including (1) the total mass of carbon or stainless steel; (2) the linear dimensions and radar cross section of a range of weapons; (3) electromagnetic phenomena specific to high carbon and stainless steel; (4) the asymmetric aspect ratio of a handgun or rifle that produces a differential signal to plane polarization; and (5) the presence of explosives that outgas detectable molecules. In some embodiments, the electromagnetic phenomena include (1) relatively “hard” magnetic properties (remanence) which produce characteristic B field transients when the targets move through strong static magnetic fields; (2) hysteresis in the presence of alternating magnetic fields; and (3) ferromagnetic resonance upon illumination at specific RF frequencies, producing retroreflection curves specific to steel having high hysteresis (“hard” ferro-metal).

In some embodiments of a weapon detection system, both high sensitivity and specificity can be achieved by sensing multiple of the above phenomena, and combing signals in each modality into a composite signal that is acceptably reliable.

In some embodiments, a weapon detection system can include a body scanner and a baggage scanner separate from the body scanner. The body scanner is configured to scan a person and the baggage scanner is configured to scan an object such as a briefcase, suitcase, purse, personal belongs in a container, etc. In some embodiments, a weapon detection system can include a scanner, which can scan and detect weapon attached to a person or in an object.

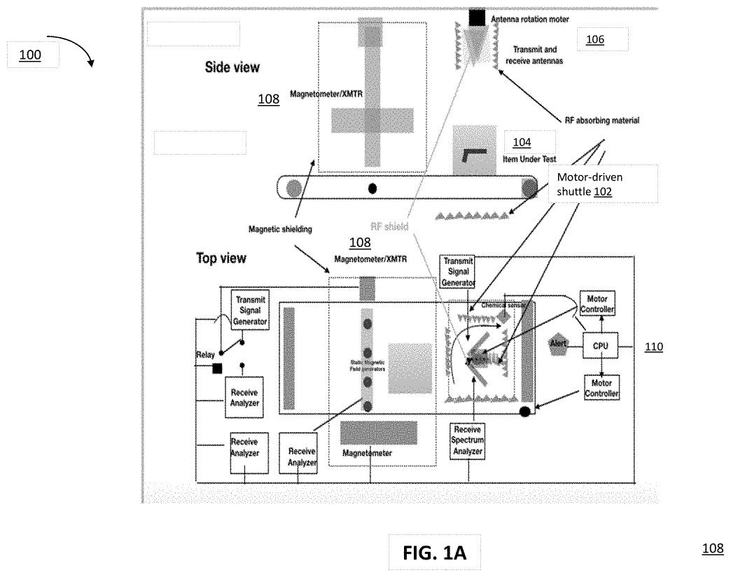

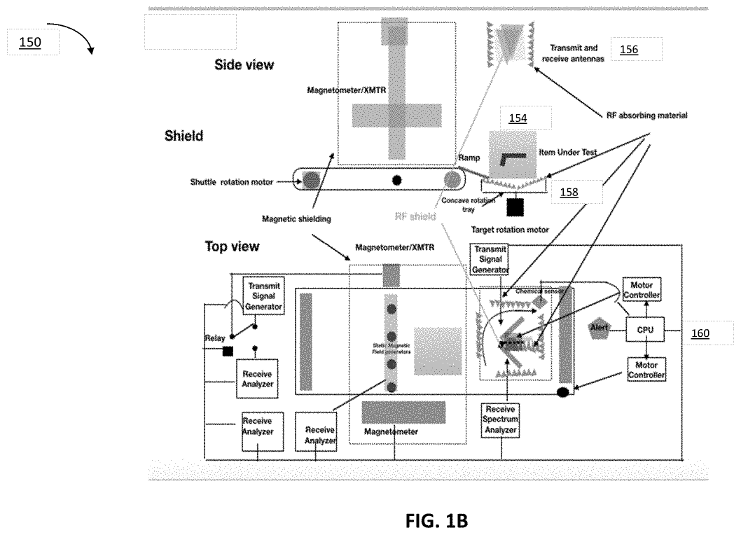

FIG. 1A is a schematic diagram of a weapon detection system 100, according to an embodiment. The weapon detection system 100 can be a baggage scanner including a motor-driven shuttle 102 that moves an item under test (IUT) 104 (also referred to herein as an item under scan, or a target) . In some implementations, the IUT 104 can be a container having metallic and/or non-metallic objects. The IUT 104 can be moved along a motion path within the weapon detection system. In some implementations, the IUT 104 can be carried by a person (not shown) and the person can move with respect to the weapon detection system 100. The weapon detection system 100 can include a radar subsystem 106, one or more magnetometers 108, static magnetic field generators (such as permanent magnets; not shown), an optional chemical sensor (not shown), a processor 110 (also referred herein to as a “Central Processing Unit (CPU)” or a “controller”), and/or other components. The weapon detection system 100 can include multiple sensors, each of which can produce a signal that collectively are part of a composite multi-source detection signal. The radar subsystem 106 includes other components and devices used to transmit a radar signal(s) and receive a radar signal(s) after interacting with the IUT 104. For example, the radar subsystem 106 can include a transmit antenna and a receive antenna, as discussed further below. The radar subsystem 106 can be, for example, based on a homodyne radar detection or pulse radar system.

In response to a signal from the CPU 110, after the IUT 104 is placed on the motor-driven shuttle 102, the motor-driven shuttle 102 moves the IUT 104 into a radar array (or a RF emitter array) in the radar subsystem 106 that emits radio frequency (RF) energy (or a set of RF excitation signals) at wavelengths for which a common range of weapon sizes can produce a strong retroreflective signal (or a set of RF response signals) based on the phenomenon of resonant absorption and re-radiation of energy for conductors at or near the half wavelength of the irradiating RF energy. A set of RF excitation signals with a single frequency, or a range of frequencies is emitted by the radar array. The range of frequencies of the set of RF excitation signals can be used to differentiate the range of dimensions (e.g., sizes, or shapes) of weapons of concern such as handguns and knives. In some implementations, as the set of RF excitations signals is emitted by the radar array, the radar transmit and receive antennas can be rotated substantially 360 degrees at a rate of 1-5 revolutions per second. In some implementations, the phase angle of the sinusoidal RF signal sent to an array of multiple transmit antennas (phased array of antennas) oriented at different polarization angles with respect to the IUT 104 is continuously changed such that the combined emission from the set of antennas rotates the polarization of the transmit signal continuously through substantially 360 degrees. Such rotation, whether produced by mechanical or phase steering, produces amplitude modulation of the retuned signal (or the set of RF response signals) that increases and decreases according to the orientation of the plane of polarization of the transmit and receive antennas to the IUT 104. For example, when the composite long axis of the IUT 104 is parallel to the plane of polarization of the transmit and receive antennas, the amplitudes of the returned signal (or the set of RF response signals) can be greater or at maximum. When the axis of orientation the composite long axis of the IUT 104 is perpendicular to the plane of polarization of the radar antennas, the amplitudes of the returned signal (or the set of RF response signals) can be lesser or at minimum. The transmit and receive antennas can be matched, and separated by a metal shield and RF absorbing material, such as carbon impregnated foam, that reduces cross talk between transmit and receive antennas. In some implementations, the plane of polarization of the transmit and receive antennas can be oriented at 90 degrees to each other to further decrease “cross talk”. The antennas are broadband devices, such as log periodic Yagi antennas with an approximately flat frequency response from 500 MHz to 3GHz. This broadband response allows use of a range of frequencies appropriate for targets of different dimensions (sizes or shapes), as well as assessment of ferromagnetic resonance, which is typically in the 2-5 GHz range for carbon and stainless steel.

FIG. 1B is a schematic diagram of a weapon detection system 150, according to an embodiment. The item under scan 154 (or IUT), such as a purse, handbag, back-pack or suitcase can be rotated and the RF transmit/receive antenna assembly 156 can be held stationary. In this embodiment the IUT 154 is sent (via a target rotation motor upon which the IUT 154 is placed) down a ramp at the end of a shuttle/conveyor into a concave tray 158 (concave to bring the IUT 154 near the center of rotation of the tray) covered in radar absorbing material to reduce cross talk between transmit and receive antennas. In these embodiments, there is less modulation of background clutter that can decrease the signal-to-clutter ratio from the relative rotation of the IUT 154 and the antennas (when the antennas rotate, all reflections from background objects can amplitude modulate, on top of the polarization sensitive modulation of the IUT 154, increasing the amplitude of sidebands, and masking the presence of a polarization sensitive target such as a handgun).

Accordingly, the peak amplitude of radar return from a continuous wave (CW) emission will oscillate at twice the rotation frequency (due to the long axis of the IUT being parallel to the radar antenna plane of polarization twice per revolution) creating sidebands that can be easily detected on a spectrum analyzer, processing the Fourier Transform of the returned signals (or the set of RF response signals).

First order sidebands can appear on both side of the CW carrier in the spectrum analyzer output analyzed by the CPU 110 or 160, with higher order sidebands extending away from the carrier which are formed, for example, when the convolution of the antenna gain pattern and target re-radiation gain pattern produce periodic, consistent modulations of the return signal (each periodic intersection of gain pattern peaks and nulls). The presence of sidebands in the spectrum analyzer output indicates presence of a conductor at or near the dimensions of interest.

Similarly stated, at least one RF signature from the set of RF response signals includes sidebands that are generated when the at least one of the transmit antenna and the receive antenna is periodically rotated with respect to the IUT, when the at least one of the array of antennas is rotated via electrical phase steering and with respect to the IUT, or when the IUT is rotated with respect to the at least one of the transmit antenna, the receive antenna, or the array of antennas. The sidebands indicate the IUT is a metal object of a length typical of a weapon.

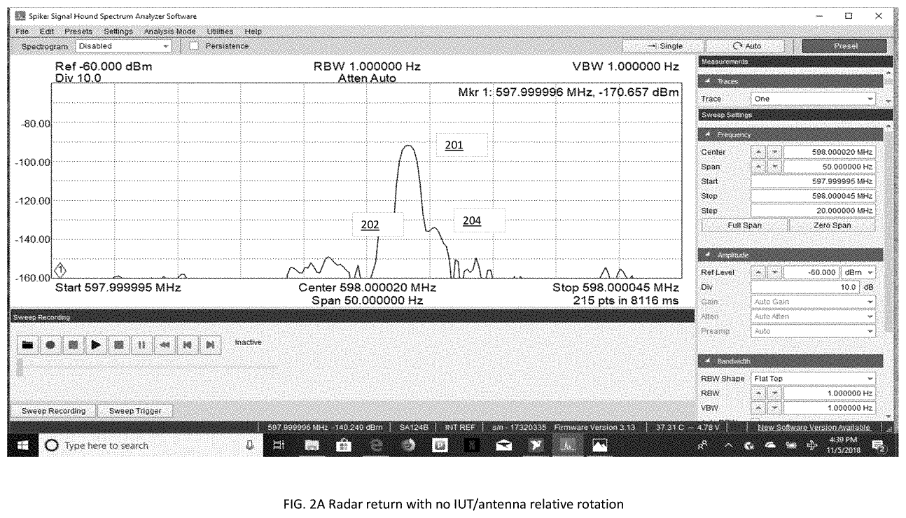

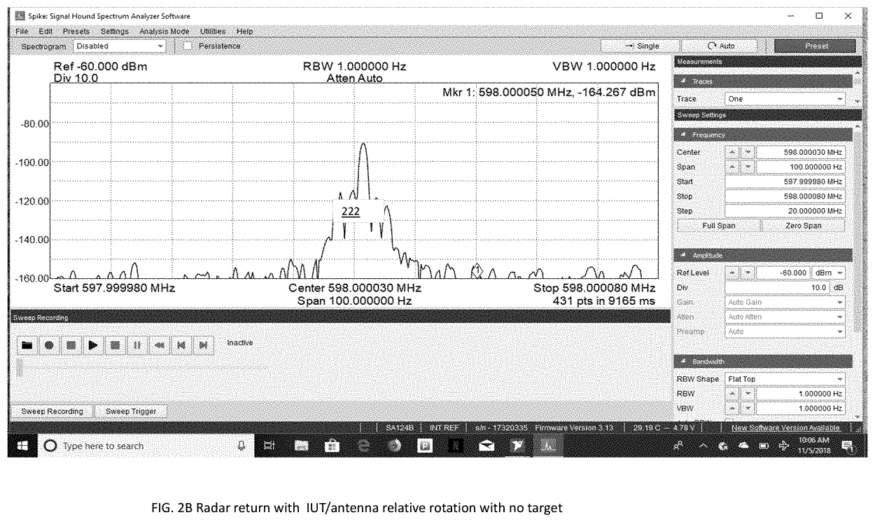

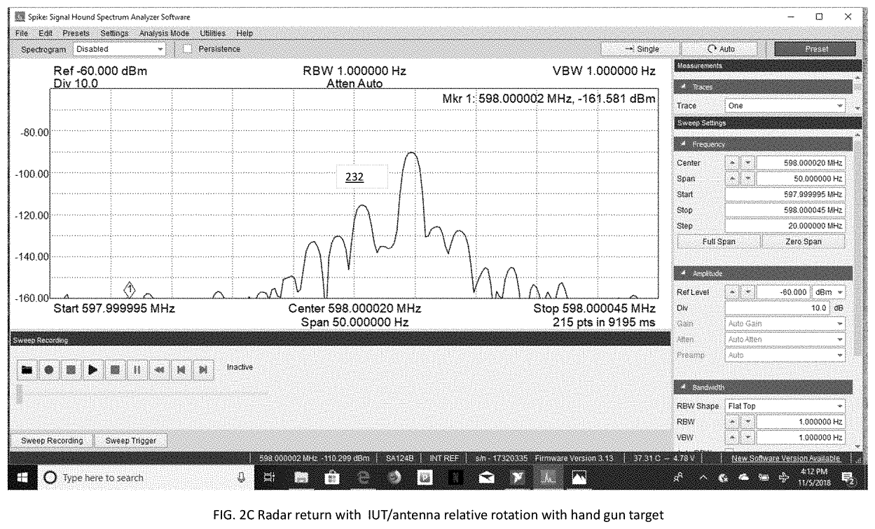

FIGS. 2A-2C show examples of a spectrum analyzer output under three conditions, accordingly to an embodiment. FIG. 2A shows the spectrum analyzer output of the set of RF response signals with no IUT and antenna relative rotation. In this instance, only cross talk between the transmit and receive antennas is present, with a peak 201 corresponding to the carrier frequency (in this case 538 MHz). The “shoulders” 202 and 204 around the carrier signal are due to phase jitter in the transmit signal source.

FIG. 2B shows a spectrum analyzer output where the transmit and receive antennas are stationary and the IUT rotates at 60 RPM (i.e., around 1 Hz). The IUT contains metallic reflectors typical of the contents of a purse, such as cell phone, keys, coins, compact mirror and nail clipper (no weapons). These are sidebands present at twice the rotation frequency (2 Hz) and at 4 times the rotation frequency (4 Hz).

FIG. 2C shows the spectrum analyzer output of the set of RF excitation signals where a weapon (e.g., a Glock 17 9MM handgun) has been added to the IUT in bag with typical metallic objects such as mobile phone, nail clippers and keys and coins. Note the presence of multiple sidebands 232 that represent the presence of the weapon, and absence of sidebands (222 in FIG. 2B) when the weapon is absent. The enhanced sidebands with the target are an indicator of the presence of weapon.

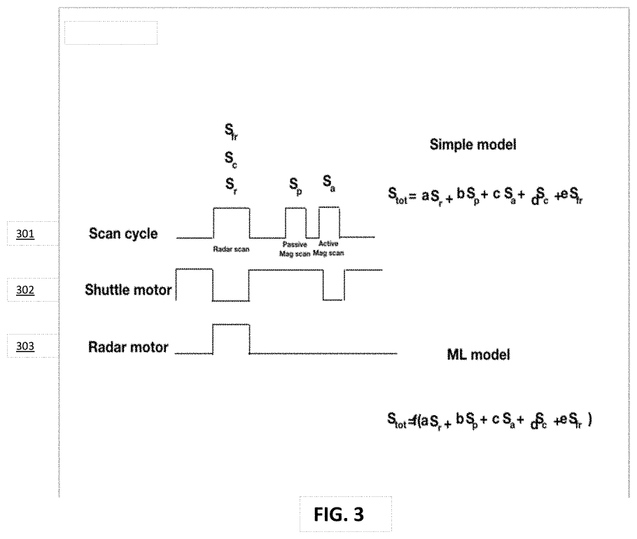

In some embodiments of the weapon detection system 100 or 150 shown in FIGS. 1A and 1B, the CPU 110 or 160 can initiate the move-scan-move cycle (as shown in FIG. 3), such that the IUT 104 or 154 is first positioned in the rotation stage (where either the radar antennas rotate with a stationary IUT or the IUT rotates with the stationary antennas) then moved past a pair of magnetometers, where two additional measures are taken. When the radar scan is complete, the CPU stores the value Sr generated from measuring energy within sidebands around the CW carrier (i.e., a set of RF response signals), then commands the shuttle to 102 move the IUT 104 or 154 over a row of magnetic field generators, such as permanent rare-earth magnets.

FIG. 3 shows an algorithm to combine multiple signals in relation to the move/scan cycle of the weapon detection system, according to some embodiments. The first scan (i.e., “scan cycle” 301), a rotational radar scan, develops a signal, Sr, based on energy in the sidebands of the spectrum analyzer (i.e., the set of RF response signals). A weighting coefficient “a” dictates the level of contribution of the radar signal to the total signal, Sₜₒₜ (i.e., the composite multi-source detection signal), and can, in some implementations, be based on empirical evidence from trials with multiple IUT configurations (different weapons, contents of purses, etc.).

The second scan (labeled “shuttle motor” 302) develops a signal Sₚ, that is proportional to the combined amplitudes of a set of magnetic signals. The set of magnetic signals are generated in response to a magnetic field by a set of magnetic field generators and detected by a set of magnetometers. A weighting coefficient “b” determines the contribution of the passive magnetic signal to the total signal Scot, and can, in some implementations, be based upon empirical evidence from multiple IUT configurations.

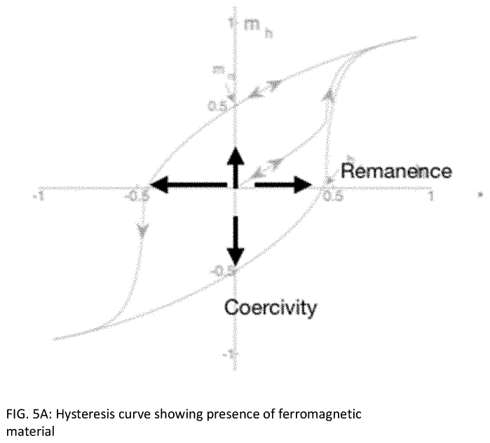

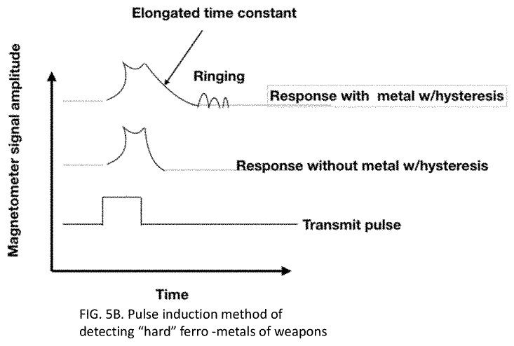

In a third scan (labeled “Radar motor” 303) with a stationary IUT a cyclically time-varying magnetic field from one set of magnetic antennas induces magnetization in ferro-metals in the IUT, generating a response that is sensed in another set of the magnetic antennas. FIG. 5A shows an example of a hysteresis curve in a “B-H” plot in which the Magnetization “H” is plotted against the incidence magnetic flux “B”.

In “hard” ferro-magnetic materials such as high carbon steel and high strength stainless steel, an oscillating magnetic field causes an increase in magnetization up to the point where all of the magnetic domains within the material are oriented with the magnetic field, at which point saturation is reached and no further magnetization occurs. Thus, when the polarity of the magnetic field is reversed, there is delay or “hysteresis” in the polarity reversal in the IUT. The coercivity of a ferro-magnetic material can be a measure of the strength of the field applied to a material that has achieved domain saturation to reverse the polarization of magnetization, and the “remenance” is a measure of the residual magnetization that persists after the magnetization field has reversed polarity or ceased. The combined coercivity and remenance amplitudes constitute the “active” magnetic signal, Sₐ, which has a weighting coefficient “c” determined by empirical experience from multiple IUT configurations.

In other words, the weapon detection system includes a set of magnetic field generators configured to collectively generate an oscillating magnetic field. The magnetometer is configured to detect ferromagnetic hysteresis characteristics of the IUT in response to the oscillating magnetic field. The weapon detection system is configured to calculate the composite multi-source detection signal based on the ferromagnetic hysteresis characteristics.

Optionally, a chemical sensor near the radar (or located with at least one of the radar subsystem or the magnetometer) can detect air currents in and around the IUT to develop a chemical signal S_{c} which the CPU also stores. This sensor might comprise a “pulse-probe” laser spectrometer or passive optical spectrometer. The S_{c} terms, as other terms, receives a weighting coefficient “d” to determine its contribution to the composite Sₜₒₜ (combined Signal from all sources) detection signal (also referred to herein as “composite multi-source detection signal,” “composite detection signal” or “total detection signal”). The chemical sensor is configured to detect a chemical present with the IUT to improve hits and correct negative responses and to decrease misses and false alarms.

In another embodiment, after the radar completes multiple revolutions and side band signals are developed, it shifts frequency up to the ferromagnetic resonance range of high carbon and stainless steel used in weapons, and an S_{fr} signal is developed, indicating the presence of metal with resonant properties appropriate for metallurgy of weapons.

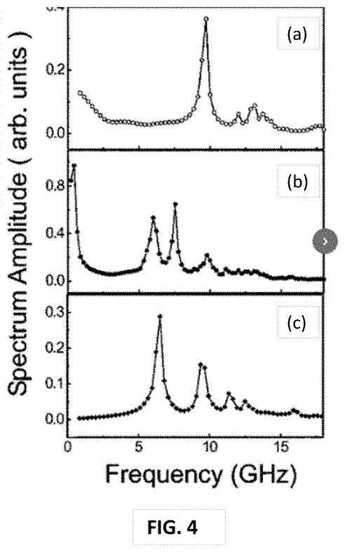

FIG. 4 shows graphs of the spectrum amplitude relative to the frequency of the source, according to an embodiment. As the frequency of a source irradiating a ferro-metal is swept, and magnitude of returned response measured, absorption peaks corresponding to resonance of the underlying ferro-metal are noted. The location of these peaks on the frequency spectrum are specific to the type of metal irradiated, as shown with different peaks in cases (a), (b) and (c) in FIG. 4. In some implementations, when peaks associated with high carbon steel or stainless steel typical of weapons are detected, an S_{fr} signal is developed with a coefficient “e” that determines the contribution of the ferromagnetic resonance term to the total detection signal “S_{tot.”}

As the shuttle moves the IUT over the static magnetic fields, two consecutive measures are taken by the magnetometer assembly. The first measurement, Sₚ, registers passive magnetometer response of three magnetometers oriented in three different planes when the IUT passes through the peak of the static magnetic fields of permanent magnets under the shuttle.

The movement of ferromagnetic metal over permanent magnet induces temporary magnetization in the metal such that, while that metal continues to move it constitutes a moving magnetic “b field” in the presence of three, orthogonally oriented induction coils. According to Faraday's law, which stipulates that the voltage induced in a coil from a nearby changing magnetic field is given as E=−dB/dt, where B is the magnetic flux and E is the induced voltage. The magnetic flux exposed to a wire consulter in a coil will in turn, be proportional to the cosine of the angle between the direction of the lines of magnetic flux of that field and the wire in which a voltage is induced. Thus, with three magnetometer coils, each oriented in one of three orthogonal planes, an arbitrarily-oriented weapon will have an optimally oriented b field with respect to at least one of the coils, improving the ability of the ensemble of three magnetometer coils to detect moving ferromagnetic metal. The output of three magnetometer coils, each positioned on opposite sides and above of the shuttle is taken to develop the Sp signal.

Similarly stated, the weapon detection system can include a first magnetometer, a second magnetometer and a third magnetometer. The first magnetometer is oriented substantially within a first plane, the second magnetometer is oriented substantially within a second plane orthogonal to the first plane, and the third magnetometer oriented substantially within a third plane orthogonal the first plane and the second plane. The first magnetometer, the second magnetometer and the third magnetometer are collectively configured to substantially maximize detection sensitivity under a range of orientations and aspect ratios of the IUT.

In some embodiments, the weapon detection system can include a set of permanent magnets disposed under a motion path of the IUT to produce momentary magnetization of the IUT while moving with respect to the weapon detection system such that changes in magnetic fields are produced at the magnetometer. In such embodiments, the set of permanent magnets can be arrayed in one of a set of patterns including a line, a set of lines, and a matrix to differentiate sizes, shapes, or ferromagnetic metal content of a set of IUTs.

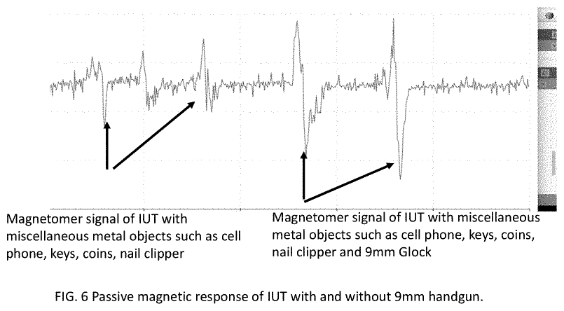

Owing to the relatively high remanence of high carbon steel and stainless steel, target passage over the static magnetic fields induces magnetization in the target which persists longer than for soft conductors such as iron, aluminum, copper and brass, thereby producing a prolonged secondary magnetic field whose change with motion is sensed in the magnetometer FIG. 6 shows an output of a magnetometer of a set of magnetic signals of the above mentioned bag with and without a target (e.g., a handgun), and with a handbag containing numerous non-weapon, metal objects such as cell phone, compact mirror, eyeglasses and keys.

The CPU then commands a relay to route an AC voltage from a signal generator , nominally at 400 HZ, but other frequencies are possible, to one of the magnetometer antennas, making that antenna radiate an alternating magnetic field when the shuttle stops just after passing the IUT over the static magnetic field generators. Due to hysteresis of the relatively “hard” carbon and stainless steel ferro-metals, the AC field produces in the receive magnetometer a signal with hysteria on a B-H plot as shown in FIG. 5A. The separation of the up magnetization and down magnetization curves on the B-H plot is measured, and a S_{fr} signal is developed and stored in the CPU. The CPU determines a coefficient, “e” , to the Str signal to weight its contribution to the overall weapon detection signal, Sₜₒₜ. In other words, the CPU can produce a B-H plot and identify at least one of high carbon or stainless steel in the IUT when the CPU calculates an alternating current (AC) magnetic field coercivity measure and a remanence measure based on the B-H plot.

In some embodiments, the oriented magnetometers are copper wire wound in multiple layers over Mu metal cores, to achieve high sensitivity, but other sensors to sense changes in magnetic fields, such as hall-effect sensors, simple wire coils or quantum magnetometers are possible. To achieve fast time response to analyze hysteresis, simple air core multi-turn coils with relatively low inductance may also be employed either as stand-alone magnetometers or in conjunction with more sensitive Mu metal core antennas.

Taking hysteresis measurements to assess the presence of ferromagnetic metals with remenance while the IUT is close to permanent magnets, enhances the detection of hysteresis effects because the strong magnetic fields push the target metals closer to saturation (a state where all possible domains within the ferromagnetic material are oriented according to the imposed magnetic field), where hysteresis effects may be observed in an alternating polarity magnetic field.

Because high carbon steel and stainless steel used in firearms and knives have been found to exhibit higher remenance and coercivity than iron or other ferro-metals, the shape of hysteresis functions sensed helps differentiate metals of interest—i.e., typically those in firearms and cutting instruments.

Other means of diagnosing the magnetic properties of IUT from hysteresis are viable including analysis of responses to pulse induction stimuli. FIG. 5B shows a graph of magnetometer signal amplitude versus time for a pulse induction method of detecting “hard” ferro-metals of weapons, according to an embodiment. As shown below in FIG. 5B, the time constant of response in a receiving magnetometer to a step function or square wave transmitted from a transmitting coil, will fall off according to the RLC time constants of the transmit and receive coils. In other words, the magnetometer can include a transmit coil and a receive coil. The receive coil is configured to produce a response having an elongation portion and a ringing portion in response to a step function or a square wave produced by the transmit coil. The elongation portion can indicate at least one of high carbon steel or stainless steel in the IUT. The ringing portion can also indicate at least one of high carbon steel or stainless steel in the IUT.

With the pulse induction method, a series of discrete square wave pulses from a signal generator is passed through a transmit coil, and the induced magnetization is sensed by a receive magnetometer. In an alternate embodiment, periodic rotation of a strong permanent magnet near the IUT will induce an impulse response that may be evaluated for hysteresis.

Once hysteresis measurements are captured the CPU then commands the shuttle to move the IUT where it is then removed, and resets the relay to normally closed such that both magnetometers are set back to passive mode.

When all scans are completed, the CPU sums the different “S” terms, as shown in FIG. 3, where each term is given a weighting coefficient that is empirically determined for example through a machine learning algorithm that is trained with a broad range of target and non-target IUTs.

If the composite signal, Sₜₒₜ, exceeds a threshold, the CPU activates an alarm notifying scanner operators that a weapon is likely present in the IUT.

The coefficients ultimately selected for developing the Sₜₒₜ will be determined through iteration, as in a simple model, or through a more complex a machine learning (ML) algorithm (or model), such as computational neural net (CNN) or gradient descent algorithm, that learns to distinguish samples where weapons are present from samples where weapons are absent, where large (>10,000) instances of different weapons-bearing and weapons-free samples are presented to the ML model. In the ML model, a function “” developed by the ML algorithm determines the coefficient weightings (e.g., coefficient weightings a, b, c, d and e) and overall transfer function of sensor inputs (e.g., Sᵣ, Sₚ, Sₐ, S_{c}, and S_{fr}) to detect outputs (e.g., Sₜₒₜ).

Sₜₒₜ=f(aSᵣ+bSₚ+cSₐ+dS_{c}+eS_{fr})

In other words, the CPU of the weapon detection system is configured to execute a machine learning (ML) algorithm to produce a set of coefficient weights. Each coefficient weight from the set of coefficient weights is uniquely associated with one of the radar subsystem, the magnetometer and/or the chemical sensor. The CPU is configured to calculate a composite multi-source detection signal based on a sum of weighted contributions of the radar subsystem, the magnetometer and the chemical sensor. The detector system employs multiple techniques to improve the signal-to-noise, and signal to clutter ratios of both the RF stage and magnetometer stages of the system.

In the RF stage, a copper or silver, highly conductive two layer shield is placed between the transmit and receive antennas to reduce cross talk between the antennas. Ideally, this conducting shield comprises of two, non contacting sheets on opposite sides of a dielectric material.

In addition, a carbon impregnated foam sheet, such as those commonly employed in RF anechoic chambers is placed between the two antennas to further reduce cross talk. Crosstalk suppression improves sensor sensitivity by reducing automatic gain control used to keep RF signals inside the dynamic range of the RF receiver. Crosstalk suppression also increases the sideband-to-carrier ratio (also referred to herein as “total sideband-energy-to-carrier metric” or “total sideband-energy-to-carrier value”), which improves both sensitivity and selectivity of the detector.

RF absorbing foam is also placed around the transmit and receive antennas to restrict antenna side lobes and multi-path propagation that increase carrier cross crosstalk, and in the case of dynamic multiparty from moving objects, degradation of carrier spectral purity due to Doppler frequency shift effects. High spectral purity and low phase noise in the RF sensor improve both sideband modulation depth (also referred to herein as “total sideband-energy-to-noise-floor metric” or “total sideband-energy-to-noise-floor value”)and the sideband-to-carrier ratio.

An additional way to reduce RF cross talk between transmit and receive antennas is to orient the antennas such that their planes of polarization are perpendicular. Although doing this reduces the returned energy from targets, such a polarization scheme reduces crosstalk to a greater degree, again increasing sideband-to-carrier ratios. Similarly stated, the radar subsystem includes a transmit antenna having a polarization and a receive antenna having a polarization, the transmit antenna is disposed substantially with respect to a first plane, the receive antenna is disposed substantially with respect to a second plane substantially orthogonal to the first plane such that cross talk between the transmit antenna and the receive antenna is reduced.

For the magnetometer sections, which feature multiple layers of coil windings around a high magnetic permeability core, such as Mu metal, a slotted electrostatic shield, shunted to signal ground is employed to reduce electronic noise power lines from RF transmissions and nearby electrical devices.

In addition, the magnetometers are housed in a Mu metal shielded compartment that greatly reduces the changes in magnetic field at the coils from ambient sources.

As shown in FIGS. 1A and 1B complete encasement in Mu metal shielding, which concentrates magnetic lines of flux, inside the shielding material so that magnetic field disturbances do not reach the coils, is achieved in one of serval ways.

For example, in one embodiment, two end cap Mu metal sheets, bent into a U shape slide over the open ends of a cubical shielded compartment, and are mechanically clamped on the main body of the compartment to minimize magnetic field “leakage”. Alternatively, the end caps can be slidably disposed within the weapon detection system so that the end caps can be inserted and removed in synchrony with motion of the IUT to decrease ambient magnetic energy detected by the magnetometer

In another embodiment, hinged Mu metal flaps (also referred to herein as “doors”) open and close at both ends of the scan chamber (e.g., an entrance of the chamber and an exit of the chamber, such that the magnetic sensing environment is enclosed on all six sides while magnetic sensing, passive and/or active, is occurring. The Mu metal flaps can be, for example, hinged to the end/walls of the chamber or other moveably attached to the end/walls of the chamber. Similarly stated, the weapon detection system can include a first door disposed at an entrance of a portion of the weapon detection system having the magnetometer. The weapon detection system can include a second door disposed at an exit of the portion of the weapon detection system having the magnetometer. The first door and the second door being positioned relative to the magnetometer while the magnetometer detects the set of magnetic response signals from the IUT to reduce ambient changes in magnetic fields from being detected by the magnetometer.

Yet another method of increasing signal to noise in the magnetometer stage is to adjust the speed of shuttle transit to increase signal strength from target materials. According to the Faraday equation E=−dB/dt. the faster a target moved over magnets passed the magnetometers the greater will be the voltage generated in the magnetometer coils. Thus, if ambient changes in magnetic fields are sensed, even inside the Mu metal shielding, it will still be possible to develop target signals in excess of ambient noise because signal strengths from moving targets will increase, while ambient magnetic noise will not.

In some embodiments, the spatial gain profile of an IUT in motion, when irradiated by an RF field at a particular frequency, interacts with the spatial gain profile of the receive antenna to generate variations in receive signal amplitude as the IUT moves with respect to the receive antenna. Careful analysis of differences in such time-varying amplitude signals can indicate whether or not a conductor the size and shape of a weapon is in the IUT.

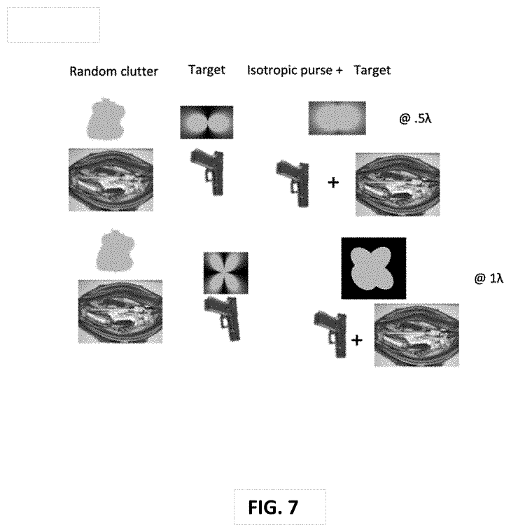

FIG. 7 shows spatial gain profiles of objects detected by the weapon detection system, according to an embodiment. As shown in FIG. 7, different objects comprising the IUT absorb and re-radiate RF energy from a nearby transmit antenna differently, depending upon the geometry and composition of the objects. A purse with typical contents, including keys, mobile phone and cosmetic items will have a crudely isotropic gain profile, whereas a handgun will have a much better resolved pattern resembling that of a dipole.

In this figure, gain profiles from irradiation of different objects are depicted at 2 different frequencies, 538 MHz (which elicits a strong response from a handgun) and double 538 MHz (1076 MHz). For 538 MHz the dimension of the handgun represents roughly one half wavelength, while for 1076 MHz the dimension of the handgun represents roughly 1 full wavelength,

IUT's containing only random RF reflecting clutter have a roughly isotropic gain pattern at frequencies representing both half and full wavelengths, but a handgun generates either a well defined two lobe pattern (at an irradiating frequency representing half wavelength) or sharp cloverleaf pattern (at an irradiating frequency representing one wavelength).

Thus, when an RF irradiated IUT with a handgun moves with respect to the receive antenna, the interaction of the handgun's radiation pattern with the receive antenna gain lobe will generate a distinctly different signal than will an isotropic—or approximately isotropic IUT radiator that does not have a handgun.

Although, as shown in FIG. 7, an irradiated IUT with both random clutter and a handgun (such as a handgun hidden inside a purse) can generate a gain profile that is less clear than either a crisp two lobe pattern or clover leaf pattern of a “pure” weapon, the gain profile of such compound clutter plus weapon IUTs can still differ enough from isotropic profiles to create unique and distinct time-varying signals when such a compound IUT moves with respect to a receive antenna and interacts with that antenna's gain lobe. Thus the presence of a weapon can be signaled by the difference between the system's response at high vs. low frequencies.

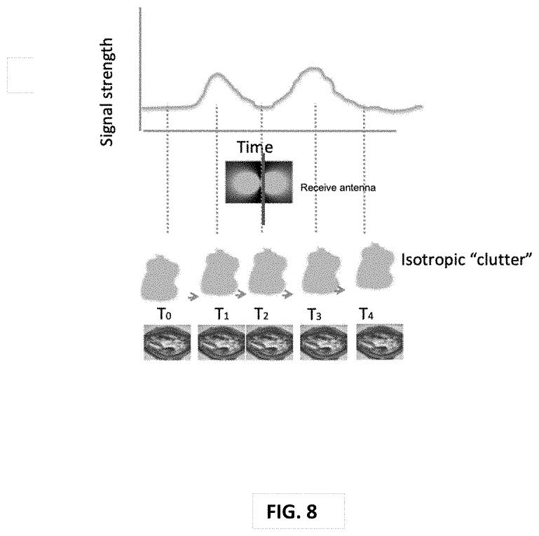

Such difference in time-varying amplitude of received signals as an IUT moves with respect to a receive antenna are shown in the FIG. 8. As shown in FIG. 8, a purse containing random RF reflecting clutter is shown in five different positions relative to dipole type antenna with a characteristic gain profile.

The purse could be moving on a conveyer belt past a receive antenna, or could be rotating in place under the receive antenna to move with respect to the receive antenna. In FIG. 8, the purse moves from left to right-as on a conveyor belt--and receiver responses (signal strength) at 5 different time epochs (T0, T1,T2,T3,T4) are shown.

As the roughly isotropic gain profile of the clutter-only IUT moves past the gain lobe of the receive antenna, a peak response develops corresponding to the maximum coupling of energy from the high gain regions of both the receive antenna and IUT occurs, followed by a sharp dip as the IUT moves into the null region of the receive antenna. But as the IUT moves past the second lobe of the receive antenna, a second peak develops as the isotropic profile of the IUT once again “stimulates” the relatively high gain of the receive antennas second lobe.

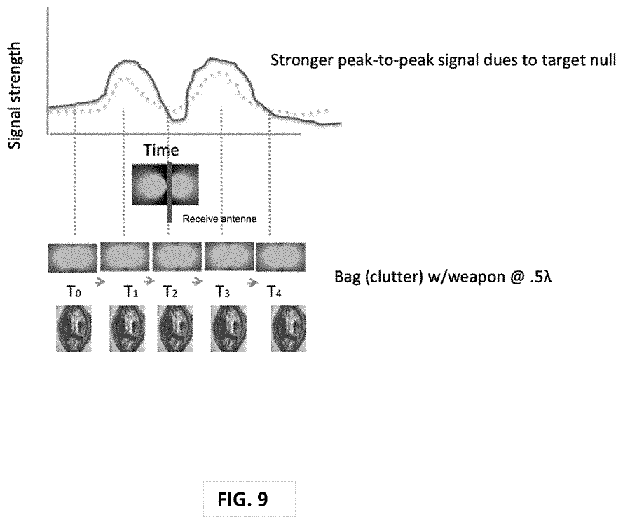

If a weapon is placed in an IUT, such as a purse containing random RF clutter, the radiation gain profile of the IUT can be more well-defined than that of an IUT containing only clutter, as shown in FIG. 9. As shown, this greater IUT gain definition, with both higher directivity gain and sharper null, can create a higher peak-to-peak amplitude of the time-varying signal as the two gain lobes and null of the gain profile of the IUT move with respect to the two gain lobes and null of the receive antenna.

Thus, one way to differentiate an IUT containing only clutter from an IUT that includes clutter plus a weapon, is to analyze the peak-to-peak amplitude of the receive signal, with a higher peak-to-peak amplitude indicating the presence of a weapon.

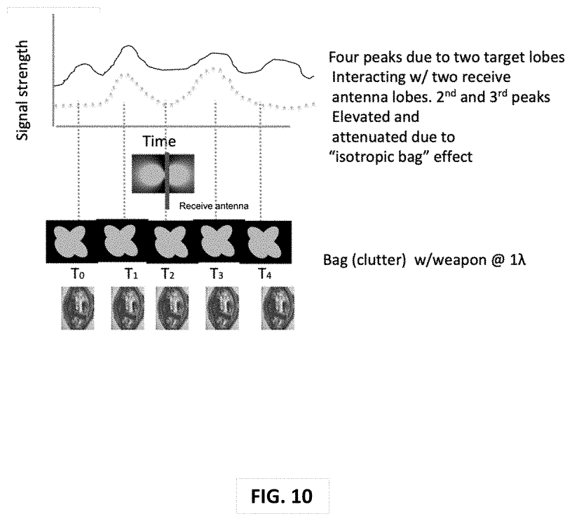

One way to greatly reduce the ambiguity of whether or not a time-varying amplitude signal represents the movement of a weapon past a receive antenna is to create a time-varying signal that is substantially different in both form and amplitude, depending upon the presence of a weapon in the IUT. As shown in FIG. 10, weapon-specific responses can be generated by irradiating the IUT with more than one frequency, to create more complex IUT radiation patterns that, in turn, create more unique time-varying receive responses as the IUT moves with respect to the receive antenna.

As shown in FIG. 10, as the IUT containing a weapon is irradiated at a frequency where the weapon represents approximately a full wavelength and moves past the receive antenna, a four-peak time-varying amplitude signal develops as two gain peaks interact—one after the other—with two distinct receive antenna gain lobes (dotted line shows previous two-peak response for reference). Because an IUT with clutter alone can have roughly the same isotropic gain profile pattern at both 0.5 and 1.0 wavelengths, a four-peak time-varying signal can strongly indicate the presence in the IUT of a conductor having the size and shape of a handgun.

As shown in FIG. 10, however, an IUT such as a purse containing a weapon will have to create a somewhat attenuated four-peak time-varying signal due to the inherent two-peak response generated by the clutter portion of the IUT.

A solution to this problem is to irradiate the IUT at frequencies corresponding to both 0.5 and 1.0 wavelengths, then to subtract the characteristic two-peak pattern of a clutter-only IUT from the four-peak response, to develop a differential four-peak signal that has greater peak-to-peak amplitude, thereby improving the ability of the system to differentiate targets from clutter.

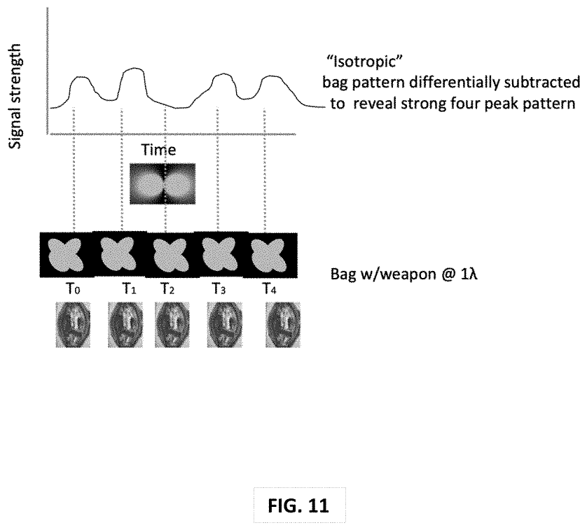

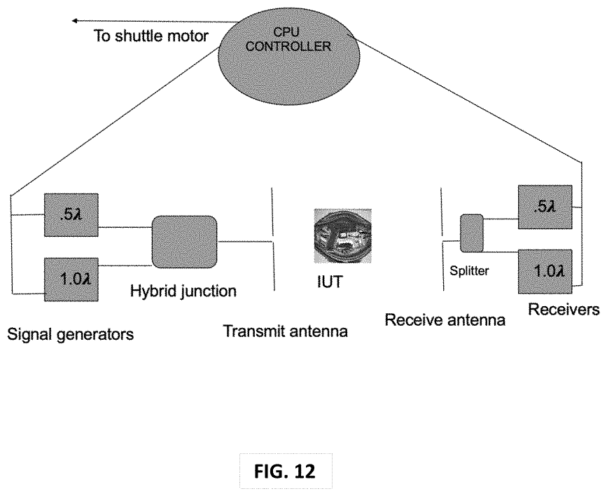

FIG. 11 shows an example of such a differential scheme. Energy at different frequencies can be radiated from the transmit antenna by combining energy at different frequencies in a hybrid mixer before routing the energy to the transmit antenna, as shown in FIG. 12. On the receive side of the system, the receive antenna feeds a splitter that routes signals to each of two receiver electronic systems at the receiver that are narrowly tuned (for example, less than 100 Hz bandwidth) to frequencies corresponding to 0.5 and 1.0 wavelengths respectively. The CPU controller digitizes time-varying signals from both receiver electronic systems, then differentially subtracts the 0.5 wavelength signal (showing two peaks from roughly isotropic radiators) from the 1.0 wavelength signal (showing four peaks from a hand gun), enhancing the signal-to-clutter ratio of the four-peak signature, signifying the presence of a conductor the size and shape of a handgun.

Frequency pairs other than 0.5 and 1.0 wavelengths are possible. Additions of more than two frequencies to enhance the signal-to-clutter ratio are also possible. In such instances, machine learning algorithms can be trained to differentiate waveforms where weapons are and are not present.

The two-frequency approach to improving target signal-to-clutter also can be applied to detecting concealed weapons on individuals who walk through a check point, without alerting those individuals that they are being scanned.

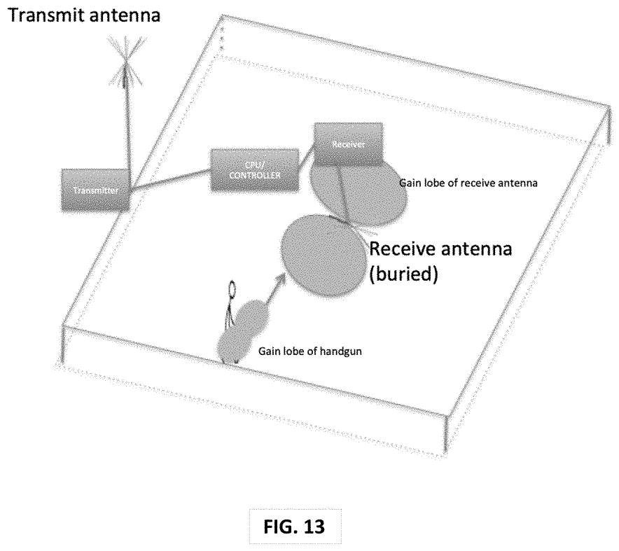

FIG. 13 depicts an example of a radar system capable of detecting weapons in unwitting pedestrians. In this system a transmitter feeds multiple frequencies (for example, at 0.5 and 1.0 wavelengths) to a broadband antenna (shown here as a double disc-cone: a fan dipole will also produce the desired gain profile), irradiating a passerby with RF energy. A receive antenna is embedded below the surface, such that when an individual walks over, or near, the antenna energy from the transmit antenna is reflected off of the pedestrian and picked up by the buried receive antenna (shown here as a broadband double disc cone).

In some embodiments, the radar subsystem includes an array of receive antennas oriented in a linear pattern. A polarization plane of the array of receive antennas rotates as the person moves relative to the array of receive antennas. The radar subsystem is configured to detect the plurality of RF response signals via the array of receive antennas, such that the weapon detection system is configured to differentiate sizes and/or shapes of a plurality of IUTs that include the IUT based on the plurality of RF response signals and the plurality of magnetic response signals.

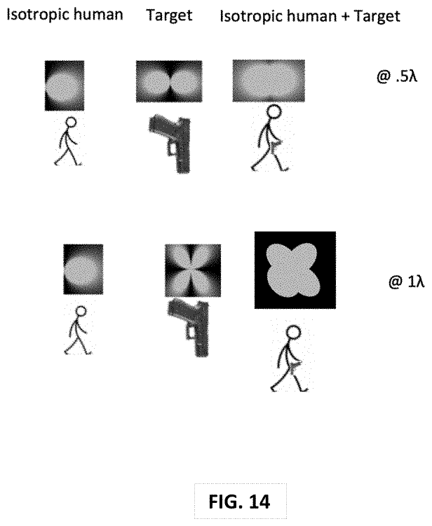

As shown in FIG. 14, a human without a weapon, radiates a roughly isotropic gain profile when irradiated at different frequencies (shown here as 0.5 and 1.0 wavelengths), but a human carrying a handgun (or other elongated metal weapon) will have a more well defined gain profile, with either two distinct lobes, or four lobes when irradiated at frequencies corresponding to 0.5 and 1.0 wavelengths respectively.

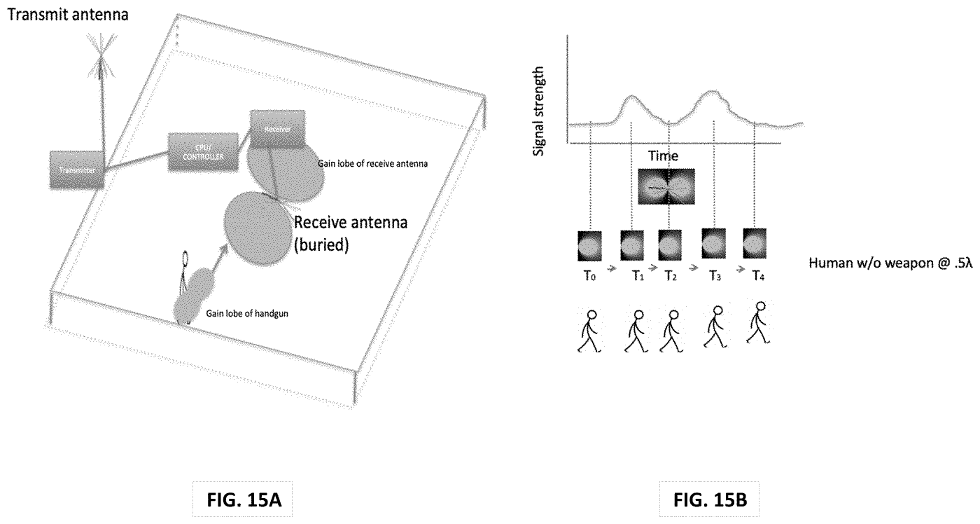

The double disc cone antenna, with a long axis parallel to the ground, will have a gain profile similar to the gain profile shown in FIG. 8, as shown in FIG. 15A, and a human walking over or near the receive disc cone antenna, will produce a two-peak time-varying signal characteristic of an isotropic radiator, as shown in FIG. 15B.

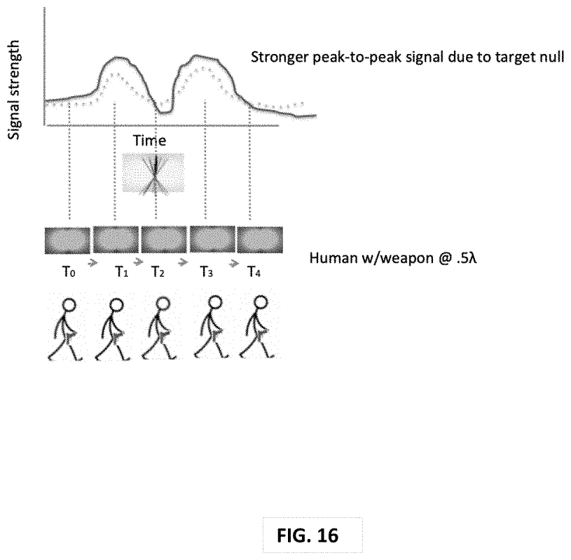

In contrast, a human walking with a weapon will have a more distinct gain profile, producing a stronger two-peak response than without a weapon, as shown in FIG. 16.

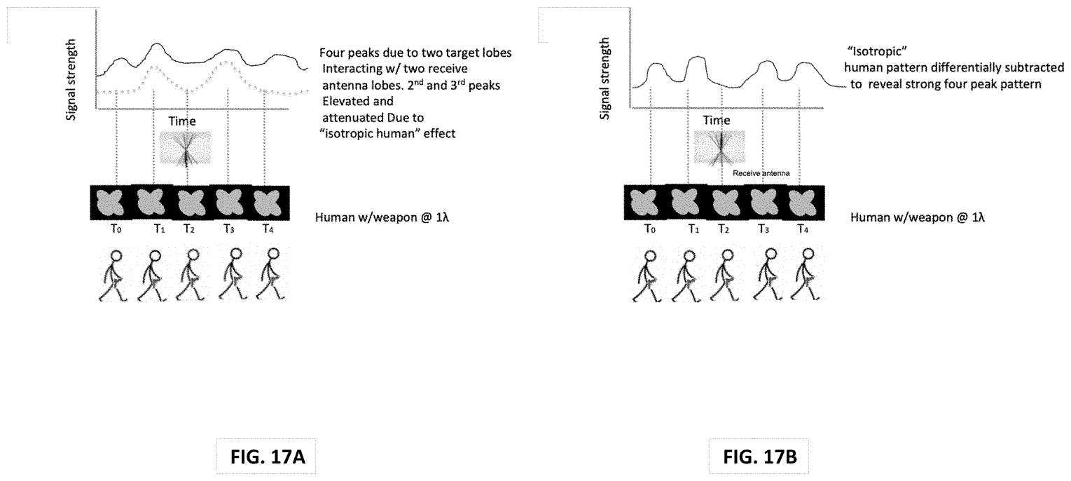

In some implementations, a two-frequency (or multiple frequencies) irradiation scheme, with differential analysis of 0.5 and 1.0 wavelength signals, can provide a strong four-peak response, indicating presence of a weapon. FIGS. 17A and 17B show an example of how the two-frequency method can enhance detection of a weapon. FIG. 17A depicts a four-peak response without differential analysis and FIG. 17B shows a clearer four-peak response after the “isotropic” two-peak response has been subtracted from the “non-isotropic” four-peak response.

It will be appreciated that both the transmit and receive antenna can be concealed such that a person walking through the transmit and receive antenna fields will not know that they are being scanned, which can enhance security by reducing countermeasures that a weapon carrying person might employ.

Different frequency pairs are feasible, as are more than two frequencies to irradiate the IUT/Human. As more frequencies are added, and results from the different waveforms they generate compared, greater precision can be achieved in discriminating the size and shape of weapon present.

In such instances, machine learning algorithms can be trained to differentiate waveforms where weapons are and are not present.

Although currently available hand-held weapon detectors rarely miss detecting weapons, owing to high sensitivity, such scanners have a very high false alarm rate and are not selective for ferrous typical of weapons and non-ferrous metals typical of “clutter.” Thus, manual checks for weapons can be time consuming and slow the scanning process.

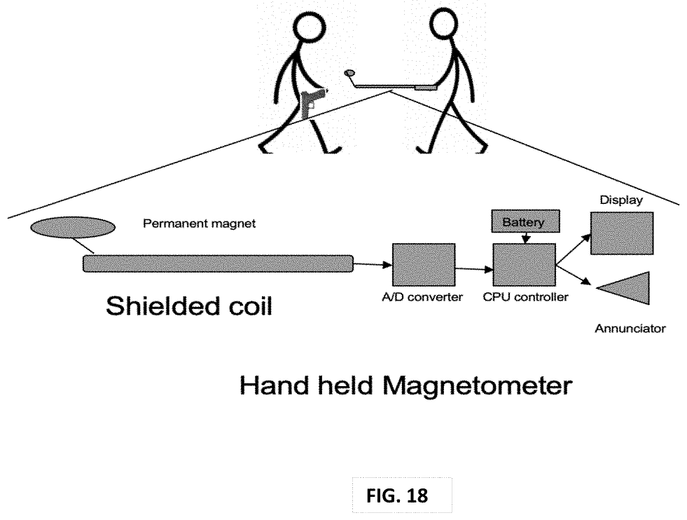

A handheld weapon detector, using principles described for the bag checking magnetometer discussed earlier, with very high selectivity for ferrous vs. non-ferrous metals and low false alarm rate, is depicted in FIG. 18.

A magnetometer coil having multiple layers of wires wound around a high permeability core (such as Mu metal) with an electrostatic shield to minimize electric field interference, sends voltage signals generated by the Faraday effect to a high resolution analog-to-digital converter (nominally 24 bits), which in turn sends digitized waveforms to a battery powered CPU controller driving a small display monitor and annunciator, such as a buzzer.

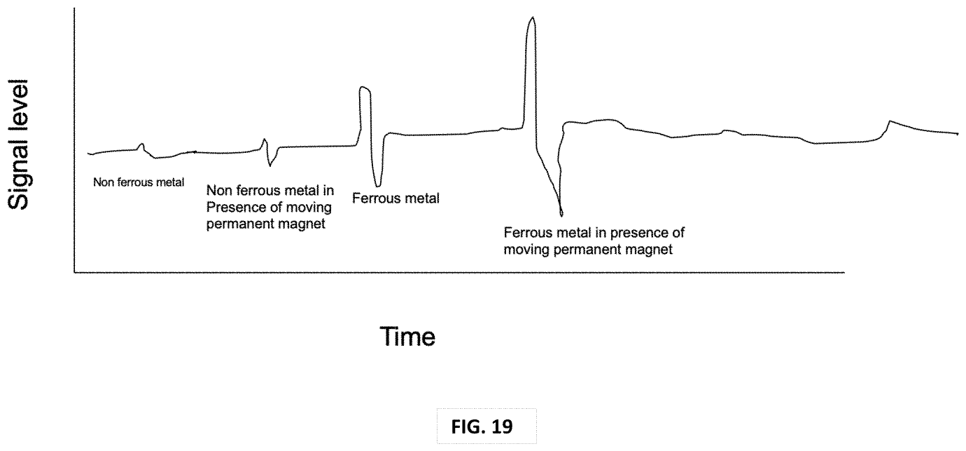

A permanent magnet attached to the end of the magnetometer coil produces a strong magnetic field, which, when moved over any conductor, will induce a changing magnetic field in that conductor that will, in turn, generate a voltage according to Faraday's law in the magnetometer coil. In some embodiments, users of the hand-held magnetometer will, in close, proximity to the person being tested, push and pull the magnetometer along the long axis of the magnetometer coil to minimize signals generated by sweeping the coil across lines of flux of the earth's magnetic field. Alternatively, the magnetometer can be translated up down or side to side, with minimal rotation about its long axis—or an axis perpendicular to the long axis—to minimize the contribution of the Earth's magnetic field. As shown in FIG. 19, the hand-held magnetometer described above can generate different signals depending upon the type of conductor that it is scanning, and whether or not a permanent magnet is attached to the magnetometer. The signal on the far left, represents the time-varying voltage from moving the hand-held detector forward and back near a non-ferrous conductor, or small ferrous conductor (for example, keys, coins or mobile phones).

The next signal, in the time series represents a stronger response when the magnetometer has a permanent magnet attached, because the permanent magnet induces a current and a changing magnetic field in the non-ferrous conductor, which are sensed by the magnetometer. The third waveform in the series represents the magnetometer response to a large ferrous weapon such as a handgun or knife. Note that, even without a permanent magnet attached to the moving magnetometer, a ferrous object will generate a significant signal in a close-by moving magnetometer, owing to changes in the earth's magnetic field near the ferrous object, which the magnetometer encounters and registers via the Faraday effect, as it moves past the ferrous object. Finally, in the presence of a moving permanent magnet, a much stronger signal is developed in the magnetometer because of both the induced current—and resulting magnetic field—in the ferrous object and the time-varying residual magnetization of the ferrous object which is sensed by the magnetometer.

As with the shuttle driven bag scanner described earlier, the presence of a weapon is indicated by both the amplitude and shape of the waveform. For example, a long knife or handgun will produce a longer lasting signal than a small ferrous object or non-ferrous conductor, as the changes in magnetic field while the magnetometer is scanned over a larger object will be of greater duration.

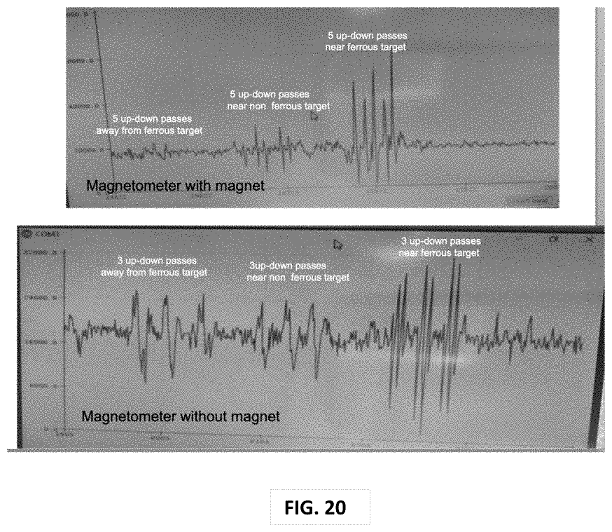

FIG. 20 includes actual traces from moving magnetometers under with and without attached magnets under three conditions: moving up and down away from a ferrous target, moving upon and down near a non-ferrous target, and moving up and down near a ferrous target with a permanent magnet attached to the moving magnetometer. By comparing the upper trace, where a magnet is attached to the magnetometer, to the lower trace, where no magnet is attached, it is apparent that the ratio of the peak-to-peak amplitude of the response to a ferrous target relative to the peak-to-peak response to a non-ferrous target (upper trace) is greater when a magnet is attached to the magnetometer. Moreover, when there is no magnet on the magnetometer, the duration and shape of the magnetometer response to a ferrous target changes considerably depending on whether the target being scanned is ferrous or non-ferrous. Thus, in one embodiment of the invention, in which a magnet is not attached to the magnetometer, such combined differences in amplitude, shape and duration of magnetometer responses to a ferrous target are used by machine learning (ML) algorithms to differentiate ferrous from non-ferrous targets. Note in FIG. 20, that both the amplitude and shape and pulse width of the waveforms differ considerably, enabling better discrimination of a target from non-target

As with the shuttle bag checker described earlier, machine learning algorithms (e.g., supervised learning algorithms, unsupervised learning algorithms, reinforcement learning algorithms, and/or the like) are implemented to further enhance the high selectivity and low false alarm rate of the hand-held weapon detector by analyzing multiple parameters (e.g. amplitude, shape, pulse width) of the waveform.

A distinct advantage of the moving-magnetometer-with magnet hand-held scanner over existing scanners, is that the weapons can be detected at longer distances without physically touching the person being scanned. Also, due to greater detection range, the hand-scanning time can be reduced because, for example, a scan along the outside of a person's leg can simultaneously detect weapons on both sides of the leg and/or secreted in the crotch.

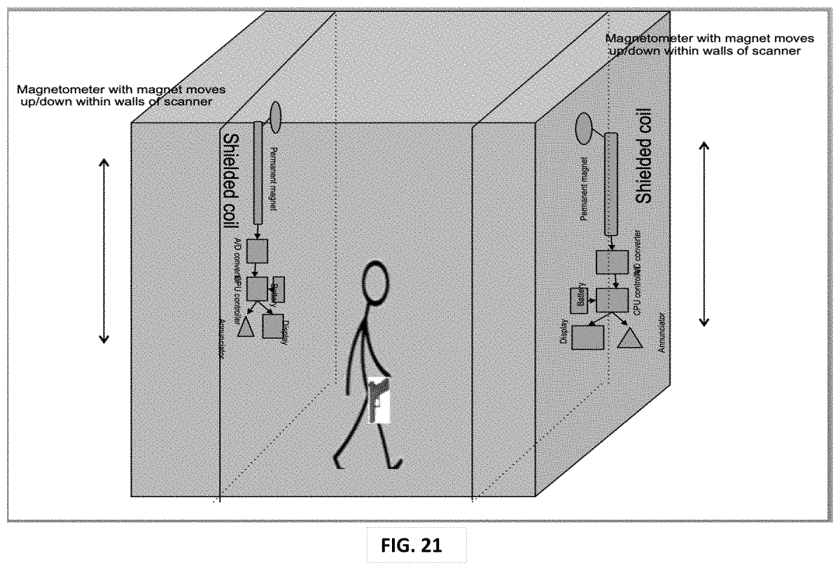

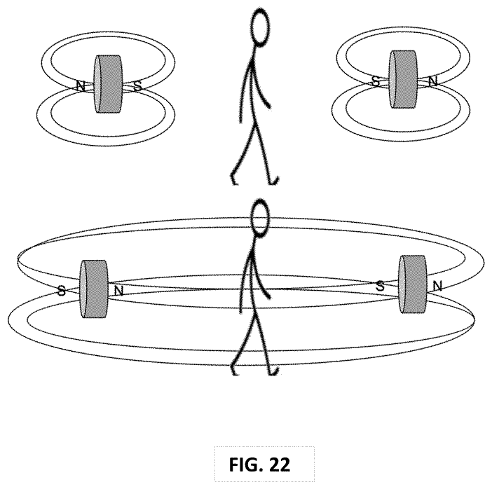

FIG. 21 shows an embodiment of the moving magnetometer scanner, two magnetometer/permanent magnet assemblies are mounted inside opposing walls of a scanner through which IUTs pass. Such an IUT could be a bag, or with a larger aperture, a human. In this embodiment, the strong (e.g., rare earth magnets such as niodiumium magnets) are mounted such that the “South pole” of one magnet directly opposes the “North pole” of the other magnet. This juxtaposition causes the lines of magnetic flux emerging from each magnet to fuse to form one long line of flux that a person passes through, thereby enhancing the magnitude of the sensed signal.

As shown in FIG. 22, when the moving permanent magnets are oriented with the same “poles” facing each other, the magnetic lines of flux do not extend (or extend very weakly) through a person walking through the detector. But when opposite poles of the two magnets face each other, the axial lines of flux are “pulled” towards each other in each magnet, creating a stronger axial (North-South) field of flux through which a pedestrian or IUT passes, thereby increasing the magnitude of Faraday effect in both moving magnetometers.

While various embodiments have been described and illustrated herein, a variety of other means and/or structures for performing the function and/or obtaining the results and/or one or more of the advantages described herein, and each of such variations and/or modifications are possible. More generally, all parameters, dimensions, materials, and configurations described herein are meant to be examples and the actual parameters, dimensions, materials, and/or configurations will depend upon the specific application or applications for which the disclosure is used. It is to be understood that the foregoing embodiments are presented by way of example only and that other embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

What is claimed is:

1. An apparatus, comprising:
a weapon detection system having a radar subsystem and a magnetometer, the radar subsystem configured to detect a plurality of radio frequency (RF) response signals from an item under test (IUT), the magnetometer configured to detect a plurality of magnetic response signals from the IUT, the weapon detection system configured to calculate a composite multi-source detection signal based on the plurality of RF response signals and the plurality of magnetic response signals.

2. The apparatus of the claim 1, wherein the radar subsystem is configured to detect ferromagnetic spectral absorption and re-radiation characteristics of the IUT to differentiate metals of concern from metals of lesser concern based on the plurality of RF response signals.

3. The apparatus of claim 1 wherein:
the plurality of RF response signals are in response to a plurality of RF excitation signals having a plurality of RF frequencies; and
the weapon detection system is configured to differentiate sizes and/or shapes of a plurality of IUTs that include the IUT based on the plurality of RF response signals and the plurality of magnetic response signals.

4. The apparatus of claim 1, wherein:
the IUT is carried on a person;
the plurality of RF response signals are in response to a plurality of RF excitation signals applied to the moving person.

5. The apparatus of claim 4, wherein:
the radar subsystem includes an array of receive antennas oriented in a linear pattern;
a polarization plane of the array of receive antennas rotates as the person moves relative to the array of receive antennas;
the radar subsystem is configured to detect the plurality of RF response signals via the array of receive antennas, and
the weapon detection system is configured to differentiate sizes and/or shapes of a plurality of IUTs that include the IUT based on the plurality of RF response signals and the plurality of magnetic response signals.

6. The apparatus of claim 1, further comprising:
a chemical sensor located with at least one of the radar subsystem or the magnetometer, the chemical sensor configured to detect a chemical present with the IUT to improve hit and correct negative responses and to decrease misses and false alarms.

7. The apparatus of claim 1, wherein the magnetometer is a first magnetometer, the apparatus further comprising:
a second magnetometer and a third magnetometer,
the first magnetometer oriented substantially within a first plane, the second magnetometer oriented substantially within a second plane orthogonal to the first plane, the third magnetometer oriented substantially within a third plane orthogonal the first plane and the second plane,
the first magnetometer, the second magnetometer and the third magnetometer collectively configured to substantially maximize detection sensitivity under a range of orientations and aspect ratios of the IUT.

8. The apparatus of claim 1, further comprising:
a plurality of permanent magnets disposed under a motion path of the IUT to produce momentary magnetization of the IUT while moving with respect to the weapon detection system such that changes in magnetic fields are produced at the magnetometer.

9. The apparatus of claim 8, wherein:
the plurality of permanent magnets are arrayed in one of a plurality of patterns including a line, a plurality of lines, and a matrix to differentiate sizes, shapes, or ferromagnetic metal content of a plurality of IUTs.

10. The apparatus of claim 1, wherein:
the radar subsystem includes a transmit antenna, a receive antenna and an RF absorbing material that is disposed within the radar subsystem to reduce crosstalk between the transmit antenna and the receive antenna.

11. The apparatus of claim 1, wherein:
the radar subsystem includes a transmit antenna having a polarization and a receive antenna having a polarization, the transmit antenna is disposed substantially with respect to a first plane, the receive antenna is disposed substantially with respect to a second plane substantially orthogonal to the first plane such that cross talk between the transmit antenna and the receive antenna is reduced.

12. The apparatus of claim 1, wherein:
the radar subsystem includes at least one of a transmit antenna, a receive antenna, or an array of antennas,
at least one RF signature from the plurality of RF response signals including sidebands that are generated when the at least one of the transmit antenna and the receive antenna is periodically rotated with respect to the IUT, when the at least one of the array of antennas is rotated via electrical phase steering and with respect to the IUT, or when the IUT is rotated with respect to the at least one of the transmit antenna, the receive antenna, or the array of antennas, and
the sidebands indicating the IUT is a metal object of a length typical of a weapon.

13. The apparatus of claim 12, further comprising:
a processor operatively coupled to the radar subsystem, the processor configured to sum energy in the sidebands to define a total-sideband-energy-to-carrier metric and a total-sideband-energy-to-noise-floor metric,
the processor configured to send a signal indicating the IUT is a weapon based on the total-sideband-energy-to-carrier metric and the total-sideband-energy-to-noise-floor metric.

14. The apparatus of claim 1, further comprising:
a plurality of end caps slidably disposed within the weapon detection system, the plurality of end caps inserted and removed in synchrony with motion of the IUT to decrease ambient magnetic energy detected by the magnetometer.

15. The apparatus of claim 1, further comprising:
a first door disposed at an entrance of a portion of the weapon detection system having the magnetometer;
a second door disposed at an exit of the portion of the weapon detection system having the magnetometer,
the first door and the second door being positioned relative to the magnetometer while the magnetometer detects the plurality of magnetic response signals from the IUT to reduce ambient changes in magnetic fields from being detected by the magnetometer.

16. The apparatus of claim 1, further comprising:
a processor operatively coupled to the magnetometer, the processor configured to produce a B-H plot, the processor configured to identify at least one of high carbon or stainless steel in the IUT when the processor calculates an alternating current (AC) magnetic field coercivity measure and a remanence measure based on the B-H plot.

17. The apparatus of claim 1, wherein:
the magnetometer includes a transmit coil and a receive coil, the receive coil configured to produce a response having an elongation portion in response to a step function or a square wave produced by the transmit coil, the elongation portion indicating at least one of high carbon steel or stainless steel in the IUT.

18. The apparatus of claim 1, wherein:
the magnetometer includes a transmit coil and a receive coil, the receive coil configured to produce a response having a ringing portion in response to a step function or a square wave produced by the transmit coil, the ringing portion indicating at least one of high carbon steel or stainless steel in the IUT.

19. The apparatus of claim 1, further comprising:
a chemical sensor located with at least one of the radar subsystem or the magnetometer; and
a processor operatively coupled to the radar subsystem, the magnetometer and the chemical sensor, the processor configured to execute a machine learning (ML) algorithm to produce (1) a plurality of coefficient weights, each coefficient weight from the plurality of coefficient weights being uniquely associated with one of the radar subsystem, the magnetometer and the chemical sensor, and (2) a composite multi-source detection signal based on a sum of weighted contributions of the radar subsystem, the magnetometer and the chemical sensor.

20. The apparatus of claim 1, further comprising:
a plurality of magnetic field generators configured to collectively generate an oscillating magnetic field,
the magnetometer configured to detect ferromagnetic hysteresis characteristics of the IUT in response to the oscillating magnetic field, the weapon detection system configured to calculate the composite multi-source detection signal based on the ferromagnetic hysteresis characteristics.

21. A system, comprising:
a radio frequency (RF) emitter array configured to emit a plurality of RF signals;
an RF receiving antenna configured to detect a plurality of RF response signals in response to the plurality of RF signals applied to an item under test (IUT);
a plurality of magnetic field generators configured to generate a magnetic field;
a magnetometer configured to detect a plurality of magnetic signals in response to the magnetic field applied to the IUT; and
a processor operatively coupled to the RF receiving antenna and the magnetometer, the processor configured to receive the plurality of RF response signals and the plurality of magnetic signals to produce a composite multi-source detection signal;
the processor configured to send, based on the composite multi-source detection signal, a reporting signal indicating a weapon presence in the IUT.

22. The system of claim 21, wherein a plurality of polarization angles associated with the plurality of the RF signals rotate in response to at least one of a mechanical rotation of the RF emitter array or a phase change of the plurality of the RF signals.

23. The system of claim 21, wherein:
the magnetic field is an oscillating magnetic field;
the magnetometer configured to detect ferromagnetic hysteresis characteristics of the IUT in response to the oscillating magnetic field magnetic field;
the magnetometer configured to detect ferromagnetic resonance characteristics of the IUT in response the plurality of RF signals;
the processor configured to produce the composite multi-source detection signal based on the ferromagnetic hysteresis characteristics and the ferromagnetic resonance characteristics of the IUT due to high composition of carbon and stainless steel in the IUT.

24. An apparatus, comprising:
a memory; and
a processor operatively coupled to the memory, the processor configured to receive a plurality of radio frequency (RF) response signals in response to a plurality of RF signals applied to an item under test (IUT),
the processor configured to receive a plurality of electromagnetic signals in response to a plurality of magnetic field generators applied to the IUT;
the processor configured to execute a machine learning (ML) algorithm to produce (1) a plurality of coefficient weights, each coefficient weight from the plurality of coefficient weights being uniquely associated with one of plurality of RF response signals and one of the plurality of electromagnetic signals, and (2) a composite multi-source detection signal based on a sum of weighted contributions of the plurality of RF response signals and plurality of electromagnetic signals;
the processor configured to send, based on the composite multi-source detection signal, a reporting signal indicating a weapon presence in the IUT.

25. An apparatus, comprising:
a permanent magnet;
a mobile magnetometer configured to be operatively coupled to the permanent magnet, the mobile magnetometer configured to be moving with respect to a target and detect an electromagnetic signal associated with the target; and
a processor configured to receive the electromagnetic signal from the mobile magnetometer,
the processor configured to execute a machine learning algorithm to generate an indicator, based on the electromagnetic signal, to indicate a ferromagnetic material presence in the target,
the processor configured to send, based on the indicator, a signal to alert the ferromagnetic material presence in the target.
